(19) United States
(12) Patent Application Publication
(10) Pub. No.: US 2009/0136074 A1
(43) Pub. Date: May 28, 2009

(54) Earphone and the Method of Making thereof

(76) Inventors: Ching-Wen Chang, Taichung (TW); Yu-Chang Fan, Taichung (TW)

Correspondence Address: Muncy, Geissler, Olds & Lowe, PLLC, P.O. BOX 1364, FAIRFAX, VA, 22038-1364, US

(21) Appl. No.: 11/945,317

(22) Filed: Nov. 27, 2007

(51) Int. Cl. H04R 25/00

(52) U.S. Cl. 381/380

(57) ABSTRACT

An earphone and its method of making are disclosed. The earphone comprises a first shell and a second shell joined thereto to form a housing. A sound pressure releasing path is defined in the housing. A loudspeaker is disposed in the housing. A strain relief collar is securely clasped between the first and second shells, and the strain relief collar has an inner molded body and an outer molded body. The inner molded body having a hardness, and the outer molded body has a hardness lesser than that of the inner molded body. A cord has an end connected to the loudspeaker, a portion encompassed by the strain relief collar and a portion extended out of the strain relief collar, wherein the sound pressure releasing path allows sound air waves to exit the earphone to the atmosphere when the loudspeaker imposes sound to the ear.

### BACKGROUND OF THE INVENTION

1. Field of the Invention

The present invention relates to an earphone and its method of making.

2. Description of the Related Art

Referring to Taiwan Pat. No. M 273,162, an earphone according to the prior art includes a first shell 10, and a second shell 20 combined to form a housing for accommodating a loudspeaker 50. The first and second shells 10, 20 also form an extension for receiving a cord therebetween, and the cord has one end electrically connected to the loudspeaker 50 and the other end extended out of the extension. An earplug 21 is formed integrally with the second shell 20 and inserted into the interior of the external auditory meatus of a wearer so as to provide high fidelity sounds to the wearer. However, on the contrary, such an earphone generates sound pressure that is encapsulated in the ear, causing a harmful effect on the ear.

Although there are some earphones that have holes formed on the earplugs to overcome this problem. It will be appreciated that the holes have a limited efficacy and the holes can make the earphone not aesthetically pleasing.

Such an earphone also easily suffers a problem of a broken circuit at an electrical connection between the cord and the loudspeaker 50, as there is normally an excessive bending happening at where the cord extends out of the extension, and as the extension is formed of hard material.

The present invention is, therefore, intended to obviate or at least alleviate the problems encountered in the prior art.

### SUMMARY OF THE INVENTION

It is therefore an object of the present invention to provide an earphone that has cord at no risk of electrical detachment from the earphone.

It is another object of the present invention to provide an earphone that has a component inserted into the interior of the external auditory meatus of a wearer for improved sound fidelity is capable of reducing sound pressure level for low frequency sounds.

It is also another object of the present invention is to provide an earphone that has a sound pressure releasing path which has no adverse effect on outlook of the earphone.

It is yet another object of the present invention is to provide an earphone and the method of making thereof.

Accordingly, the earphone of the present invention comprises a first shell and a second shell joined with the first shell and forming a housing. A sound pressure releasing path is defined in the housing. A loudspeaker is disposed in the housing. A strain relief collar is securely clasped between the first and second shells, and the strain relief collar has an inner molded body and an outer molded body encompassing the inner molded body. The inner molded body having a hardness, and the outer molded body has a hardness lesser than that of the inner molded body. Furthermore, a cord having an end connected to the loudspeaker, a portion encompassed by the strain relief collar and a portion extended out of the strain relief collar, wherein the sound pressure releasing path allows sound air waves to exit the earphone to the atmosphere when the loudspeaker imposes sound to the ear.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an earphone in accordance with the present invention.

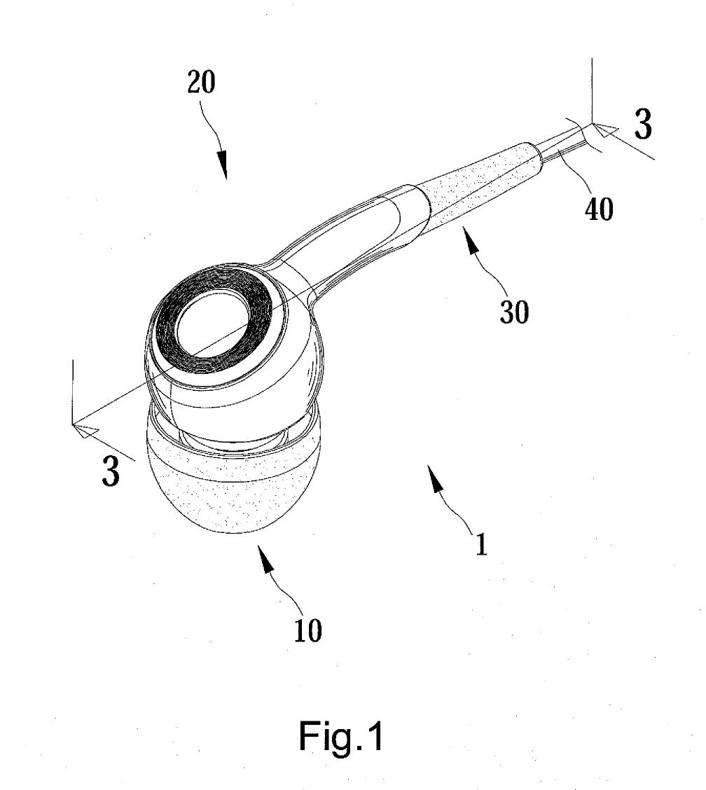

FIG. 2 is an exploded perspective view of the earphone.

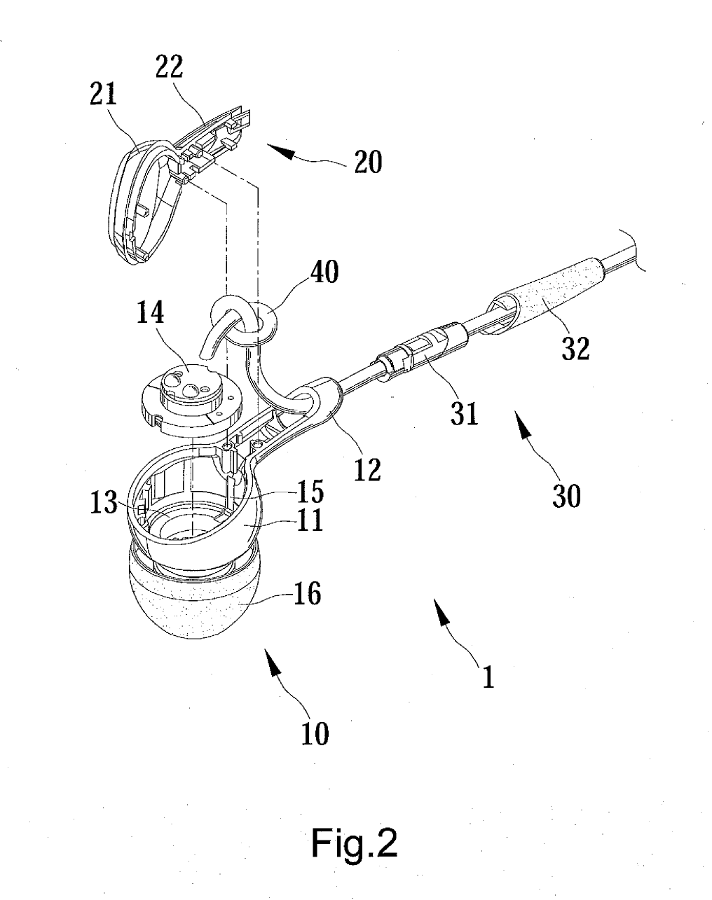

FIG. 3 is a cross-sectional view taken along a line 3-3 in FIG. 1.

FIG. 4 is similar to FIG. 3, but illustrating the cord of the earphone can be prevented from being bent too close to a vertical relationship with respect to the earphone.

FIG. 5 is a partial enlarged view of FIG. 3.

FIG. 6 is another partial enlarged view of FIG. 3.

FIG. 7 is yet another partial enlarged view of FIG. 3.

FIG. 8 is a graph illustrating sound pressure level-frequency curves of the earphone according to the present invention and the earphone of the present invention without a sound pressure releasing path being fabricated.

### DETAILED DESCRIPTION OF THE PREFERRED EMBODIMENT

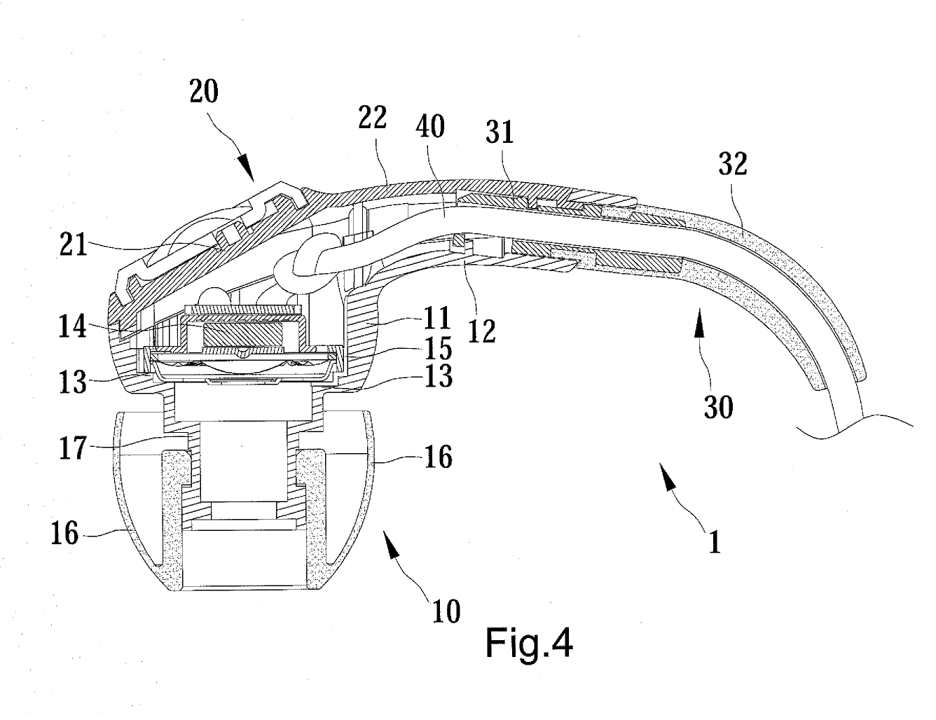

Referring to the drawings, an earphone in accordance with the present invention comprises a first shell 10 having a first wall 11 circumscribing a first compartment in which being received a loudspeaker 14. The first shell 10 further includes a second wall 12 extended from the first wall 11 contiguously and circumscribing a second compartment. A strain relief collar 30 partially received in the first shell includes an inner molded body 31 and an outer molded body 32 encompassing the inner molded body 31. In this embodiment, the inner molded body 31 is produced by injection molding first. Then the outer molded body 32 with a hardness lesser than that of the inner molded body 31 is also produced by injection molding to extend circumscribingly around the inner molded body 31. A cord 40 is thereafter inserted through the inner molded body 30 of the strain relief collar 30 and the second compartment of the first shell 10, and the cord 40 has one end electrically connected to the loudspeaker 14, a portion encompassed by the strain relief collar 30 and a portion extended out of the strain relief collar 30. As a result, the cord 40 is at no risk of being bent too close to a vertical relation with respect to the earphone 1 and detaching from the loudspeaker 14, as shown in FIG. 4. Preferably, the cord 40 is tied with a knot before connecting to the loudspeaker 14 via a welding process. A second shell 20 complemently joined on the first shell 10 for encapsulating the loudspeaker 14 and partially encapsulating the strain relief collar 30 includes a first wall 21 and a second wall 22 extended from the first wall 21 contiguously. The first wall 21 and the second wall 22 of the second shell 20 correspondingly fit to the first wall 11 and the second wall 12 of the first shell 10, respectively.

Other structural features of the earphone 1 includes an edge 13 formed by the first wall 11 of the first shell 10 for supporting the loudspeaker 14 within the first compartment. A sound pressure releasing path 15 is fabricated from the edge 13 and extended upward and toward the second compartment. An earplug 17 is extended contiguously from the first wall 11 of the first shell 10 and includes an earplug sheath 16 fitted thereon. The earplug 17 is adapted to be inserted into the interior of the external auditory meatus of a wearer so as to provide high fidelity sounds to the wearer. Furthermore, an interstice is defined radially between the inner molded body 31 and the cord 40.

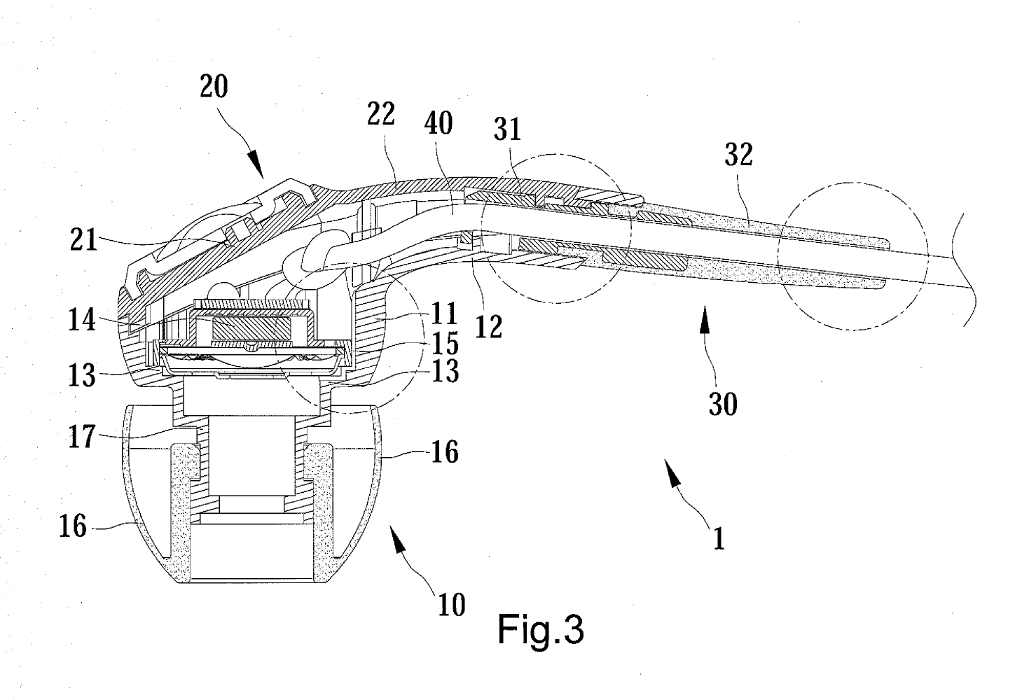

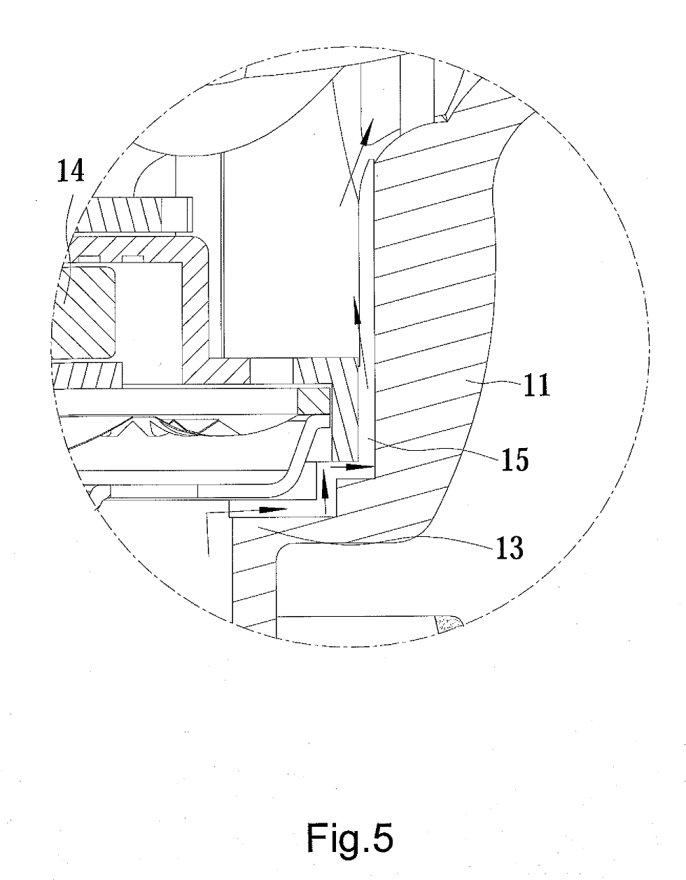

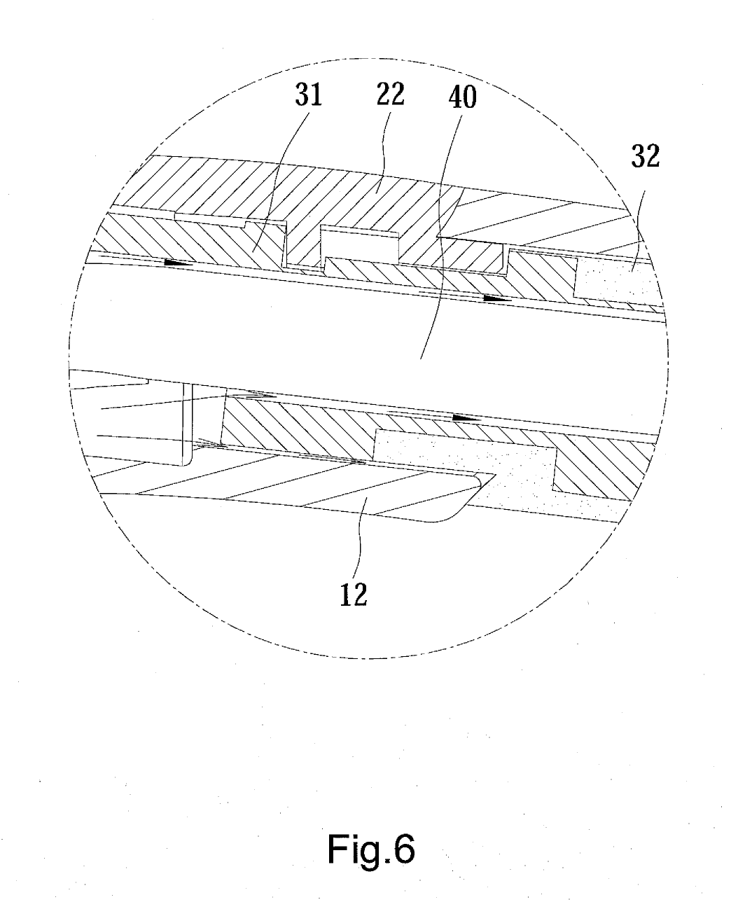

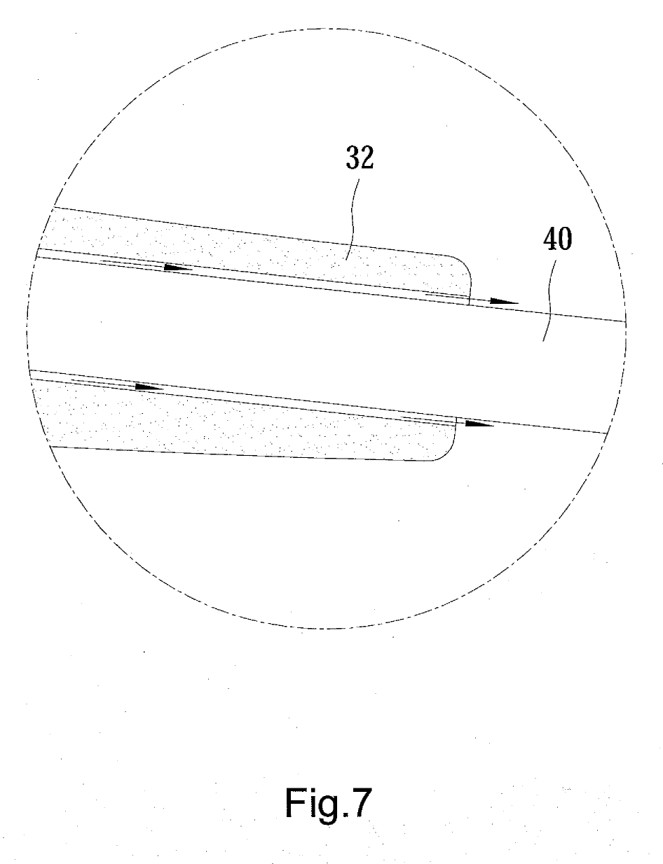

Referring to FIG. 3 in conjunction with FIGS. 5, 6 and 7, it is to be noted that sound air waves are able to exit the earphone 1 to the atmosphere through the sound pressure releasing path 15 and the interstice, thus reducing the problem that low frequency sound is encapsulated in the ear, which will impose high sound pressure level on the ear.

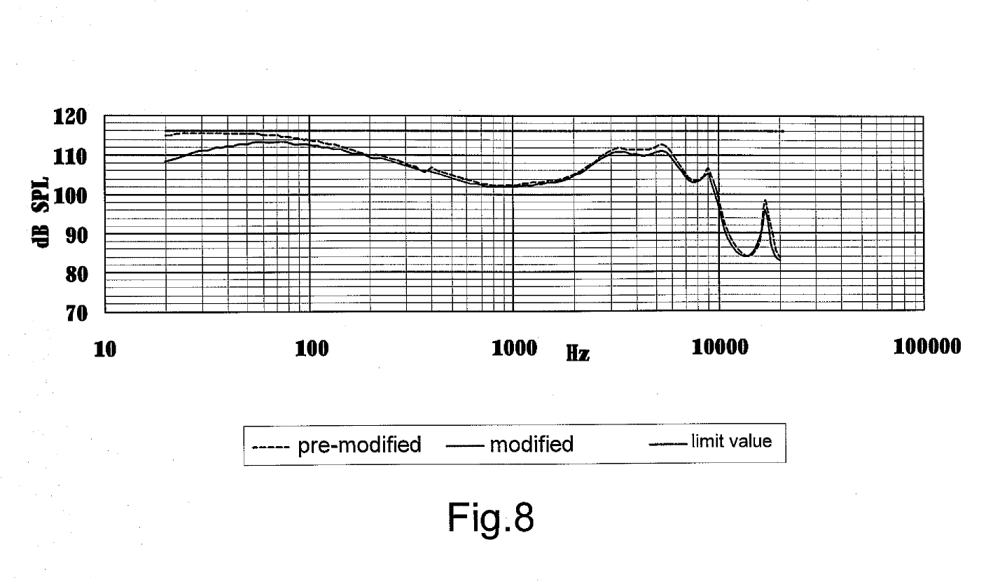

Referring to FIG. 8, a graph illustrates sound pressure level-frequency curves of the earphone according to the present invention (in solid line) and the earphone of the present invention without a sound pressure releasing path being fabricated (in dashed line). It is to be noted that sound pressure level (SPL) is comparatively reduced when the sound pressure releasing path is fabricated, particularly for low frequency sound. As an example, SPL value has decreased from 115 dB to 108 dB at 20 Hz, and SPL value is no longer close to the limit value at a frequency ranging from 30 to 50 Hz.

While the specific embodiments have been illustrated and described, numerous modifications come to mind without significantly departing from the spirit of invention and the scope of invention is only limited by the scope of accompanying claims.

What is claimed is:

1. An earphone comprising:
a first shell and a second shell joined thereto to form a housing;
a strain relief collar, securely received between the first and second shells, having an inner molded body and an outer molded body encompassing the inner molded body, and the inner molded body having a hardness greater than that of the inner molded body; and
a cord being insertable into the inner molded body of the strain relief collar.

2. The earphone as claimed in claim 1, wherein the first shell comprises a first wall circumscribing a first compartment in which being received a loudspeaker and a second wall extended from the first wall contiguously and circumscribing a second compartment.

3. The earphone as claimed in claim 2, wherein the first shell comprises an edge for supporting the loudspeaker within the compartment.

4. The earphone as claimed in claim 2, wherein the strain relief collar comprises an interstice defined radially circumscribing the cord.

5. An earphone comprising:
a first shell and a second shell joined thereto to form a housing;
a loudspeaker disposed in the housing; and
a sound pressure releasing path defined in the housing; and
wherein the sound pressure releasing path allows sound air waves from the loudspeaker to exit the earphone to the atmosphere.

6. The earphone as claimed in claim 5, wherein the first shell comprises a first wall which circumscribes a first compartment and a second wall which extends from the first wall contiguously, and the loudspeaker is receivable in the first compartment.

7. The earphone as claimed in claim 6, wherein the first shell comprises an edge for supporting the loudspeaker within the first compartment, and the sound pressure releasing path is fabricated from the edge and extended toward the second compartment.

8. The earphone as claimed in claim 5, further comprising a strain relief collar securely received between the first and second shells, and the strain relief collar includes an inner molded an outer molded body formed of different hardness encompassing the inner molded body, and wherein the strain relief collar includes a cord insertable into the inner molded body.

9. The earphone as claimed in claim 8, wherein the outer molded body has a hardness lesser than that of the inner molded body.

10. A method for making an earphone comprising steps of:
injection molding an inner molded body;
injection molding an outer molded body which encompasses the inner molded body externally to form a strain relief collar, and the outer molded body has a hardness lesser than that of the inner molded body;
providing a cord insertable through the strain relief collar; and
providing a first shell which includes a first wall circumscribing a first compartment and a second wall which extends from the first wall contiguously and circumscribes a second compartment, and a second shell which complemently attaches to the first shell to encapsulate the strain relief collar therebetween.

11. The method for making an earphone as claimed in claim 10, further comprising:
fabricating a sound pressure releasing path on the first wall of the first shell.

12. The method for making an earphone as claimed in claim 10, further comprising:
providing a loudspeaker disposed in the first compartment.

13. The method for making an earphone as claimed in claim 10, further comprising:
forming an edge for supporting the loudspeaker within the first compartment.

14. The method for making an earphone as claimed in claim 13, wherein the sound pressure releasing path is fabricated from the edge and extended toward the second compartment.

15. The method for making an earphone as claimed in claim 12, further comprising:
tying the cord with a knot before electrically connecting to the loudspeaker.
